(19) United States
(12) Patent Application Publication
(10) Pub. No.: US 2009/0147221 A1
(43) Pub. Date: Jun. 11, 2009

(54) MINIATURIZED PROJECTION DISPLAY

(75) Inventors: Marcellinus P.C.M Krijn, Eindhoven (NL); Bart Andre Salters, Eindhoven (NL); Oscar Hendrikus Willemsen, Den Bosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,405

(22) PCT Filed: Nov. 28, 2005
(86) PCT No.: PCT/IB05/53937

§ 371 Date: May 16, 2007

Related U.S. Application Data
(60) Provisional application No. 60/631,842, filed on Nov. 30, 2004.
(60) Provisional application No. 60/656,123, filed on Feb. 24, 2005.

(51) Int. Cl. G03B 21/14

(52) U.S. Cl. 353/33; 353/31

(57) ABSTRACT

A projection device is disclosed. The projection device comprises a plurality of LEDs (202, 204, 206) each generating light of a known wavelength, a light path associated with, and receiving the light from, each of the LEDs, each light path comprising a VA wavelength retarder (213, 223, 233), a first optical selection means (243, 253, 263)) providing orientation of a known direction to light applied thereon, the first optical selection means further reflecting light having an orientation not in the known direction, an LCD panel (232, 234, 236, and a second optical selection means (245, 255, 265) providing orientation of light applied thereon substantially orthogonal to the first known direction, and a recombination cube (240) in communication with each of the light paths for recombining the light received from each of the light paths, wherein the orientation of light received from at least one light path is substantially orthogonal to the orientation of light received from the remaining light paths.

This application is related to the field of optical projection devices and, more particularly, to a miniaturized projection display.

Recently much progress has been made in increasing the brightness of light-emitting diodes (LEDs). As a result, it is anticipated that LEDs will become sufficiently bright and inexpensive to serve as the light source in front and rear projection displays. These new and brighter LEDs would be suitable for the projection of high-quality video with a large color gamut and high contrast. The use of LEDs also will allow front projection displays for portable applications.

Hence, there is a need in the industry for projection devices that incorporate the available LED technology.

A projection device is disclosed. The projection device comprises a plurality of LEDs for generating light of a known wavelength, a light path associated with, and receiving the light from, each of the LEDs, each light path comprising a ¼ wavelength retarder, a first optical selection means that allows the passage of light that fulfills a known requirement—e.g., correct polarization, of light applied thereon, the first optical selection means further reflecting light having an orientation not in the known direction, and a second optical selection means providing orientation of light applied thereon that is substantially orthogonal to the first known direction, and an LCD panel and a recombination cube in communication, wherein the orientation of light received from at least one light path is substantially orthogonal to the orientation of light received from the remaining light paths.

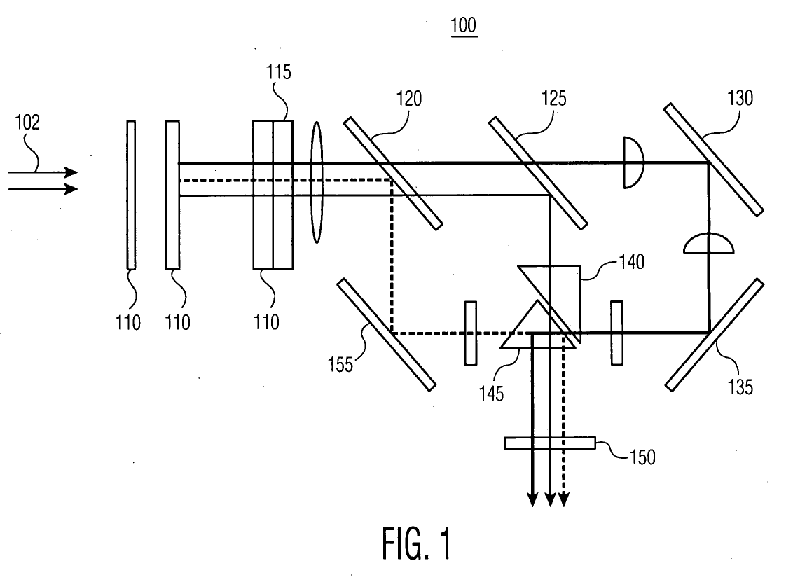

FIG. 1 illustrates a diagram of a conventional HTPS (High Temperature Poly Silicon) projection device;

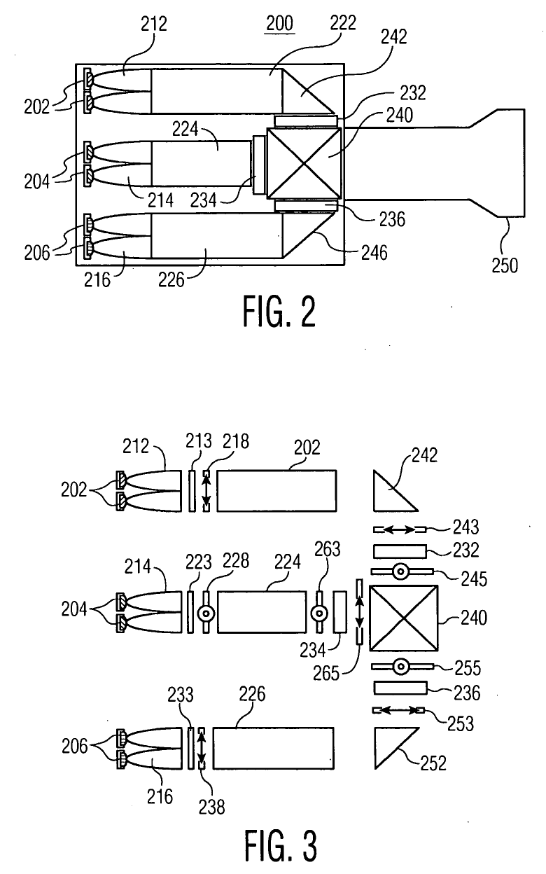

FIG. 2 illustrates a cross-sectional view of an exemplary embodiment of a portable projection device in accordance with the principles of the invention;

FIG. 3 illustrates an exploded view of the projection device shown in FIG. 2; and

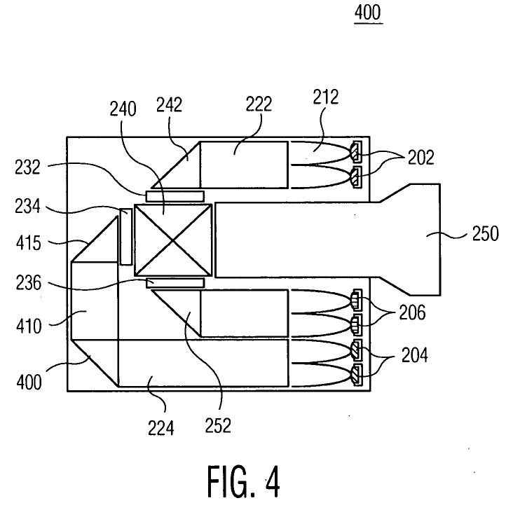

FIG. 4 illustrates a cross-sectional view of a second exemplary embodiment of a portable projection device in accordance with the principles of the invention.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

FIG. 1 illustrates a conventional 3-panel HTPS projector 100 with a UHP lamp (not shown) as the light source. In this conventional projector, the light, represented by rays 102, from a high-pressure gas-discharge lamp (not shown) is mixed, i.e., integrated, by means of a two fly-eye lens 110 in between the lamp (not shown) and a first dichroic filter 120. Dichroic filter 120 splits the light into blue and red+green component elements wherein the blue light is reflected towards mirror 155. The red+green component is transmitted towards lens 125. Dichroic mirror 125 will then split the red+green light component and green light is reflected towards the X-cube 140, while the red light is transmitted towards mirror 130. The flat mirrors 125, 130 and 155, which may be dichroic or normal, are used to guide each of the three spectral light parts towards a corresponding micro-display liquid crystal panel of the transmissive type 150. The micro-display liquid crystal panel 150 may be conventionally based on a high-temperature poly-silicon type. Other technologies that are used for projection devices are 1-panel LCos (Liquid-Crystal-on-silicon) and 1-panel DMD (Digital-micro-mirror-device).

After traversing the panels, the three spectral parts are recombined by means of a recombination cube containing dichroic filters 140, 145. Polarizers or analyzers, which are optical selection means, are positioned in the front and behind the panel to select as much of the light into a well-defined state of polarization. Polarizers and analyzers are essentially identical components with the property that they are, ideally, 100% transparent for light with a known polarization direction, e.g., horizontal, while 100% blocking, or reflecting, light with an orthogonal polarization direction, e.g., vertical. The polarizer in front of panel 150 assures that only light with a known polarization direction reaches the LCD panel. Hence, only light from pixels deemed to be “on” may pass the polarizer or analyzer and continue to the projection screen. More specifically, the LCD panels work by selectively changing the polarization direction, on a pixel basis. So a pixel in the bright state will change the polarization direction, while a pixel in a dark state does not. If provided with a bundle of light with just one polarization direction, the “output light” after the LCD panel is modified such that an analyzer will now block light only from “dark pixels.” Light from “bright pixels” is passed through and projected onto the screen.

FIG. 2 illustrates a first exemplary embodiment of the present invention. In this exemplary 3-panel system, three individual light sources 202, 204, and 206 have uncoupled light paths. In a preferred embodiment the light sources 202, 204, and 206 are light-emitting diodes (LEDs), each generating a light of a known wavelength. Preferably, the light generated is associated with the light-color wavelengths red, green and blue.

The light generated by LEDs 202, 204, and 206 is collected and collimated by an associated collimator 212, 214, and 216. Collimators 212, 214, and 216 may be in the form of compound parabolic concentrators (CPCs) or other similar concentrators for collecting and focusing as much light as possible generated by a corresponding LED. In an optional embodiment, which is shown in FIG. 2, integrators 222, 224 and 226 may be incorporated into the light path to be used to ensure a substantially uniform illumination of panels 232, 234 and 236 by the light generated by associated LEDs 202, 204, and 206. Integrator 222, 224, and 226 may be a glass or plastic (e.g., PMMA) rod in which light propagates by means of total internal reflection (TIR), or a hollow tunnel with reflecting side walls. It may be straight or have a tapered shape. As it would be recognized, in this optional embodiment, the longer the integrator, the more uniform the illumination of the corresponding panel.

Panels 232, 234, and 236 are positioned at the end of a corresponding integrator and used to form the image that is projected onto the screen. As the LCD panels work by selectively blocking light, the uniformity on the screen of a completely white picture is determined by the uniformity of the light that is projected onto the panel. Also shown, prisms 242 and 246 are used as directing means to direct light 202 and 206, respectively, onto corresponding panels 232 and 236.

Recombination cube 240 is used to combine the image of the three individual panels into a single-color image that is projected through projection lens 250.

FIG. 3 illustrates an exploded view of the projector shown in FIG. 2 to more clearly illustrate the principles of the present invention to increase the light transmitted to recombination cube 240. In general a polarizer absorbs half of the light since the light originating from the source is unpolarized. In the present embodiment of the invention, a broadband ¼ wavelength retarder in combination with a reflective polarizer positioned between the collimator and integrator is advantageous in increasing the light transmitted to the recombination cube 240.

More specifically, and with reference to the light path associated with LED 202, a broadband ¼-wavelength retarder 213 is used in combination with reflective polarizer 218 between LED 212 and integrator 222, in the optional embodiment shown. In this case, polarizer 218 transmits horizontally polarized light (as represented by the arrow direction in the plane of the drawing) and reflects non-horizontally polarized light back to the source 202, e.g., vertically polarized. As the reflected light passes twice through the ¼-wavelength retarder 213, its direction of polarization is changed into a direction such that that light can pass through the reflective polarizer 214. In this manner, approximately 25 percent (25%) of the light that otherwise would be lost may be recovered. Ideally, the reflective polarizer 218 has no absorption loss. For example, a Vikuiti™ DBEF (Dual Brightness Enhancement Foil) produced by the 3M Company may be used as the reflective polarizer shown.

Also shown is prism 242 that directs the polarized light to polarizer 243, which has the same polarization as polarizer 218 and allows substantially 100% of the light to pass onto panel 232. The light passing through panel 232 is then provided to analyzer 245, which has a direction of polarization orthogonal to that of polarizer 243. The orthogonal polarization of polarizer 245 is presented by the filled circle within the open circle, which represents a polarization perpendicular to the plane of the drawing. Hence, in this illustrated case, the light emitted from LEDs 202 is vertically polarized when applied to recombination cube 240.

As one skilled in the art would recognize, the light path traversed by the light emitted from LEDs 206 is similar to that described with regard to the path of light emitted from LEDs 202 and need not be described in detail.

With regard to the light emitted from LEDs 204, this light is applied to ¼-wavelength retarder 223 and vertical polarizers 228 and 263. The vertically polarized light is then applied to LCD 234 and then horizontal polarizer 265. Hence, horizontally polarized light is applied to recombination cube 240.

For compactness, the optical components may be held together by means of an optical adhesive, or coupled by means of a fluid, having an index of refraction that is closely matched to that of the optical components described. As it would be recognized, the prisms 242, 246 exhibit a high index of refraction (e.g., SF1 glass, n=1.72) to ensure that all the light entering the prism is reflected by means of TIR rather than leaking out. In another aspect, the prisms 242 and 246 may be of a low index glass in combination with a dielectric mirror that is used to reflect the light.

FIG. 4 illustrates a second exemplary embodiment of the invention. In this illustrative embodiment, the light sources 202, 204, and 206 are positioned substantially in a forward plane of the recombination cube 240. In this case, the light from source 204 is directed (re-directed) toward recombination cube 240 with the addition of prisms 405 and 415. The operation of this embodiment of the invention is similar to that described with regard to FIG. 3 in that horizontally polarized light is provided to LCD 234 while vertically polarized light is provided to LCD 232 and 236 and need not be discussed in detail herein.

Although not shown, it would be appreciated that the matching polarizer sets (e.g., 218, 243) may be positioned on the same side of collimator 222. In this case, the single polarizer provides a double function of (1) only transmitting light with the correct polarization direction towards LCD panel 232, and (2) reflecting the “other light” with the intent of recycling this one.

While there has been shown, described, and noted fundamentally novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, while the present invention has been described with regard to horizontal and vertical polarization, it would be within the skill of those versed in the art to incorporate vertical and horizontal polarization, respectively. Accordingly, it is expressly intended that all combinations of those elements that perform substantially the same function in substantially the same way to achieve the same results are within the scope of the invention. Substitutions of elements from one described embodiment to another are also fully intended and contemplated.

1. A projection device comprising:
a plurality of LEDs (202, 204, 206) each generating light of a known wavelength;
a light path associated with, and receiving the light from, each of the LEDs, each light path comprising:
a ¼ wavelength retarder (213, 223, 233);
a first optical selection means (243, 253, 263) providing orientation of a known direction to light applied thereon, the first optical selection means further reflecting light having an orientation not in the known direction;
an LCD panel (232, 234, 236); and
a second optical selection means (245, 255, 265) of a direction substantially orthogonal to the first direction; and
a recombination cube (240) in communication with each of the light paths for recombining the light received from each of the light paths, wherein the orientation of light received from at least one light path is substantially orthogonal to the orientation of light received from the remaining light paths.

2. The projection device as recited in claim 1 further comprises a collimator (212, 214, 216) positioned between an associated LED (202, 204, 206) and light path.

3. The projection device as recited in claim 1, wherein the light path further comprises an integrator (222, 224, 226).

4. The projection device as recited in claim 3, wherein the integrator is positioned between the ¼-wavelength retarder and the first optical orientation means.

5. The projection device as recited in claim 3, wherein the integrator is positioned between the first optical selection means and the LCD panel.

6. The projection device as recited in claim 1, wherein selected ones of the light paths further comprise directional means (242, 252) positioned between the LED and the LCD panel for directing light to an associated panel

7. The projection device as recited in claim 6, wherein the directional means (242, 252) is selected from the group consisting of a prism having a high index of refraction and a prism having a low index glass in combination with a dielectric mirror.

8. The projection device as recited in claim 1, wherein the LEDs are selected from the group consisting of red, green and blue LEDs.

9. The projection device as recited in claim 1, further comprising a third optical selection means (218, 228, 238) providing an optical orientation substantially the same as the first optical orientation means positioned between the first and second optical orientation means.

10. A projection device comprising:
a red, blue and green LED (202, 206, 204);
a light path associated with each of the red and blue LEDs comprising:
¼-wavelength retarder (213, 233);
a first optical selection means (243, 253) providing a first orientation to light applied thereon;
a directional means (242, 252);
a second optical selection means (245, 255) providing a second orientation to light applied thereon substantially orthogonal to the first orientation;
a light path associated with the green LED comprising;
¼-wavelength retarder (223);
an optical selection means (263) providing the second orientation to light applied thereon;
an optical selection means (265) providing a first orientation to light applied thereon; and
an LCD panel (232, 234, 236) associated with each of the light paths; and
a recombination means (240) in communication with each of the LCD panels.

11. The projection device as recited in claim 10, further comprising:
a collimator (212, 214, 216) in each of the light paths.

12. The projection device as recited in claim 10, further comprising an integrator (222, 224, 226) in each of the light paths.

13. The projection device as recited in claim 10, wherein each of the light paths further comprises a third optical selection means (218, 228, 238) providing an orientation to light applied thereon substantially similar to that of the first optical selection means.

14. The projection device as recited in claim 10, wherein the light path associated with the green light further comprises directional means (405, 415).

15. A method for providing a miniaturized projection device containing a red, blue and green LED (202, 206, 204), said method comprising the steps of:
providing a first light path for the red LEDs and a second light path for the blue LEDs, wherein the each light path comprises:
¼-wavelength retarder (213, 233) for retarding light applied thereon;
a first optical selection means (243, 253) for providing a first orientation to light applied thereon;
a directional means (242, 252) for altering the direction of light in the light path;
a second optical selection means (245, 255) for providing a second orientation to light applied thereon, the second orientation is substantially orthogonal to the first orientation;
providing a light path associated with the green LED, wherein the path comprises:
¼-wavelength retarder (223);
an optical selection means (263) providing the second orientation to light applied thereon;
an optical selection means (265) providing a first orientation to light applied thereon; and
providing an LCD panel (232, 234, 236) each of the light paths; and
a recombination means (240) in communication with each of the LCD panels.

16. The method as recited in claim 15, further comprising the step of:
providing a collimator (212, 214, 216) with each of the light paths.

17. The method as recited in claim 150, further comprising the step of:
providing an integrator (222, 224, 226) with each of the light paths.

18. The method as recited in claim 15, wherein each of the light paths further comprises the step of:
providing a third optical selection means (218, 228, 238) for light applied thereon substantially similar to that of the first optical selection means.

19. The method as recited in claim 15, wherein the light path associated with the green light further comprises step of:
providing directional means (405, 415).
